(19) United States
(12) Patent Application Publication
(10) Pub. No.: US 2009/0188468 A1
(43) Pub. Date: Jul. 30, 2009

(54) Modified common rail fuel injection system

(76) Inventor: Joseph Carl Firey, Seattle, WA (US)

Correspondence Address: Joseph C. Firey, PO Box 15514, Seattle, WA, 98115-0514, US

(21) Appl. No.: 12/011,569

(22) Filed: Jan. 29, 2008

(51) Int. Cl. F02M 69/46

(52) U.S. Cl. 123/456

(57) ABSTRACT

A modified common rail fuel injection system, for diesel engines, is described, for use with slurry fuels comprising dissolved supplementary atomizing gases. Two separate high pressure fluid circuits are utilized to supply and operate the engine fuel injectors. A high pressure fuel circuit comprises, a high pressure pump delivering engine fuel into a fuel common rail, from which the fuel is delivered into each fuel injector, and from there into each engine combustion chamber. A high pressure hydraulic circuit comprises, a high pressure pump delivering hydraulic fluid into a hydraulic common rail, from which the hydraulic fluid acts on drivers of the injector valves, via timed on-off valves, to operate each fuel injector at the proper time in each engine cylinder cycle. Reliable operation of the fuel injectors is not impaired by slurry fuel degassing or slurry fuel particles.

### CROSS REFERENCES TO RELATED APPLICATIONS

The invention described herein is closely related to my following U.S. patent applications:
(1) Supplementary Slurry Fuel Atomizer and Supply System, U.S. patent application Ser. No. 11/633,107, issued as U.S. Pat. No. 7,281,500, 16 Oct. 2007.
(2) Common Rail Supplementary Atomizer for Piston Engines, U.S. patent application Ser. No. 11/805,889, filed 25 May 2007.
(3) Rotary Residual Fuel Slurrifier, U.S. patent application Ser. No. 11/796,714, filed 30 Apr. 2007.

This material is incorporated herein by reference thereto.

### BACKGROUND OF THE INVENTION

The cross referenced U.S. patent applications describe apparatus for creating multicomponent slurry fuels, and modified piston engine common rail fuel injection apparatus for more efficient utilization of these slurry fuels, in medium and small bore internal combustion engines. Adequate atomization of high viscosity fuels, such as residual petroleum fuels, and tars from tar sands, as required for use in medium and small bore diesel engines, can be achieved by preatomizing the fuels into a slurry of very small fuel particles, suspended in a continuous water phase. The full combustion benefits of this preatomization can be realized by dissolving, at high pressure, supplementary atomizing gases, into the water phase of the slurry. At the reduced pressure in the engine combustion chamber these supplementary atomizing gases come out of solution, and assure complete separation of the preatomized fuel particles. In this way, the rapid and complete burning of high viscosity fuels, needed for efficient fuel utilization, can be obtained in medium and small bore diesel engines, presently limited to using expensive distillate fuels, which are increasingly in short supply.

Prior art common rail fuel injection systems use the high pressure fuel to operate the drivers for opening and closing of the fuel injector valve, and the fuel on-off valve, which precedes the fuel injector valve. Some of these valve drivers use flow restrictor passages to limit valve opening and closing speeds. Slurry fuels containing solid fuel particles, such as pulverized coal and shredded farm cellulose, if used to operate these valve drivers, could impair the operation by obstructing such flow restrictor passages. Slurry fuels containing dissolved supplementary atomizing gases could also impair the operation of these valve drivers due to gas evolution where a pressure drop took place. A common rail fuel injection system capable of operating properly on a wide variety of fuels, including conventional distillate fuels, slurry fuels containing solid fuel particles, and slurry fuels containing supplementary atomizing gases, would substantially assist in the achievement of national energy independence.

### SUMMARY OF THE INVENTION

A modified common rail fuel injection system of this invention utilizes a separate hydraulic fluid for the operation of the drivers of the fuel injector value, and the fuel on-off valve, except for part of the opening of the fuel on-off valve. In this way the properties of a slurry fuel, or other fuel, do not impair the operation of the common rail fuel injection system. Small and medium bore piston internal combustion engines, fitted with modified common rail fuel injection systems of this invention, can be operated efficiently and reliably on a wide variety of fuels. This is one of the principal beneficial objects of this invention, that a major portion of the engines, needed to operate our national transportation system, can use, not only conventional petroleum fuels, but alternative slurry fuels comprising residual petroleum fuels, tar from tar sands, pulverized coal, as well as renewable components, such as shredded farm or other cellulose materials.

### BRIEF DESCRIPTION OF THE DRAWINGS

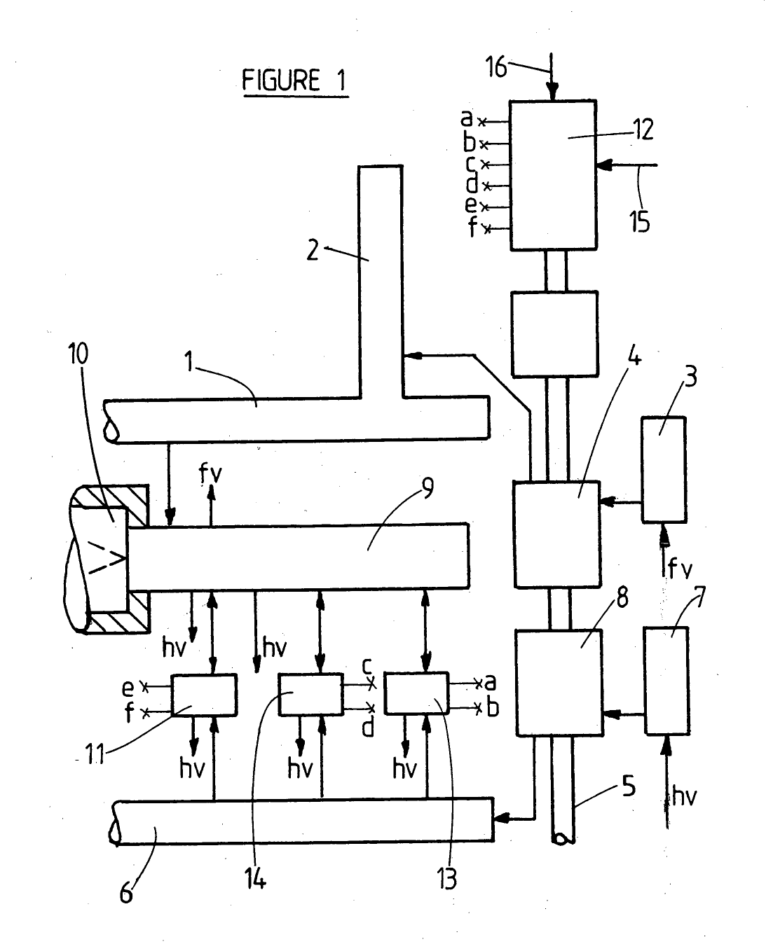

A schematic diagram of a modified common rail fuel injection system of this invention is shown in the block diagram of FIG. 1.

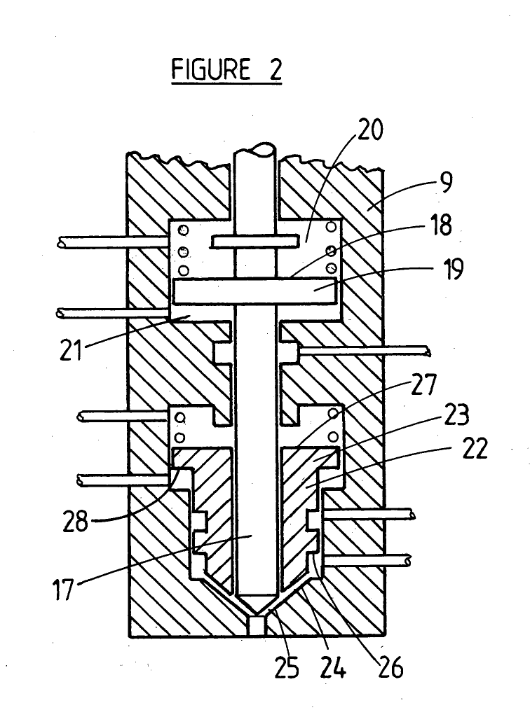

A cross section view of an example fuel injector suitable for use in a modified common rail fuel injection system is shown in FIG. 2.

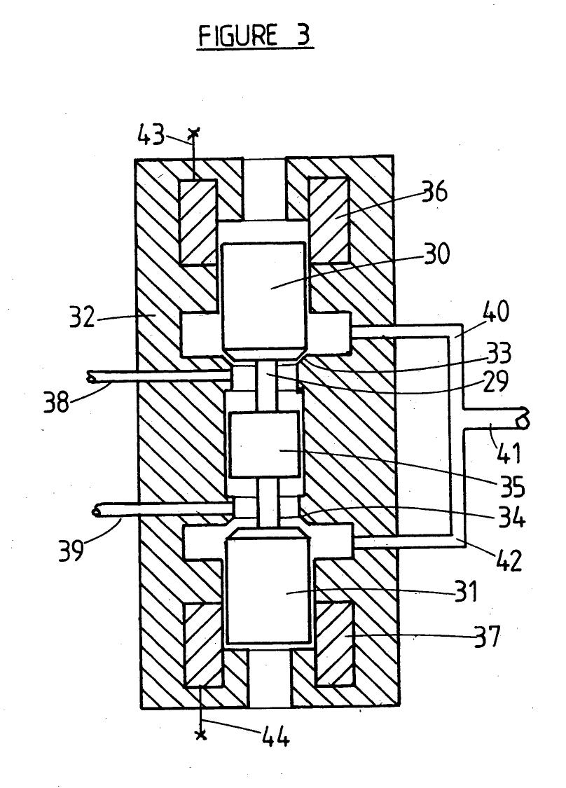

A cross section view of one example timed pressure and vent balanced valve, for applying hydraulic pressure, to and from the valve drivers of the fuel injector is shown in FIG. 3.

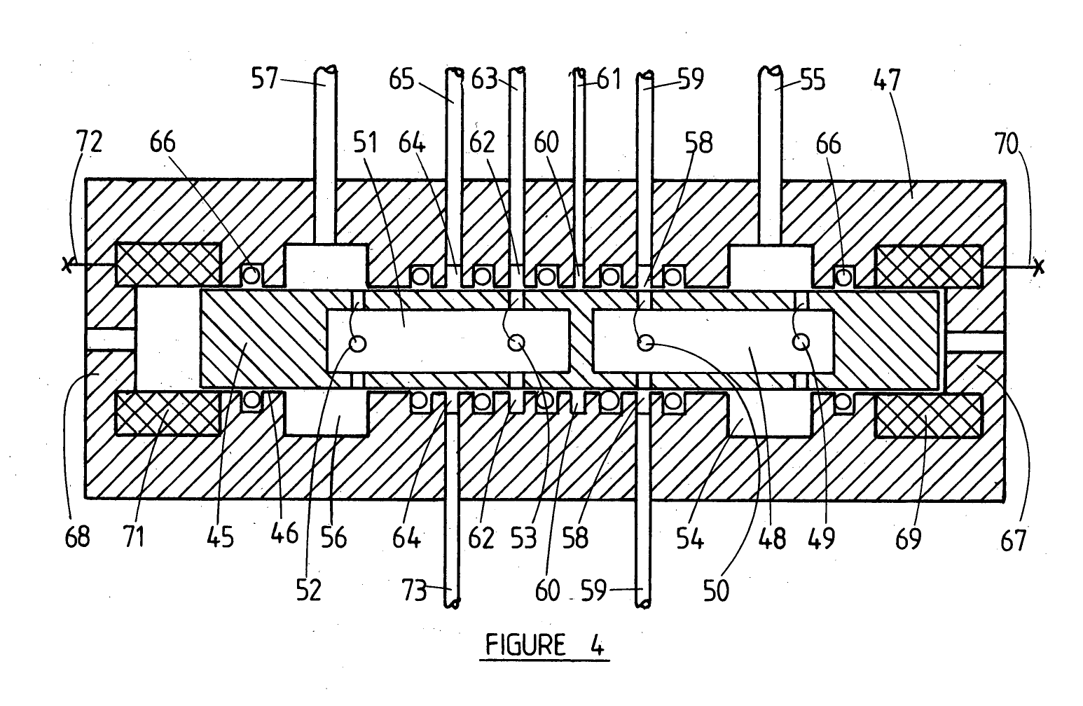

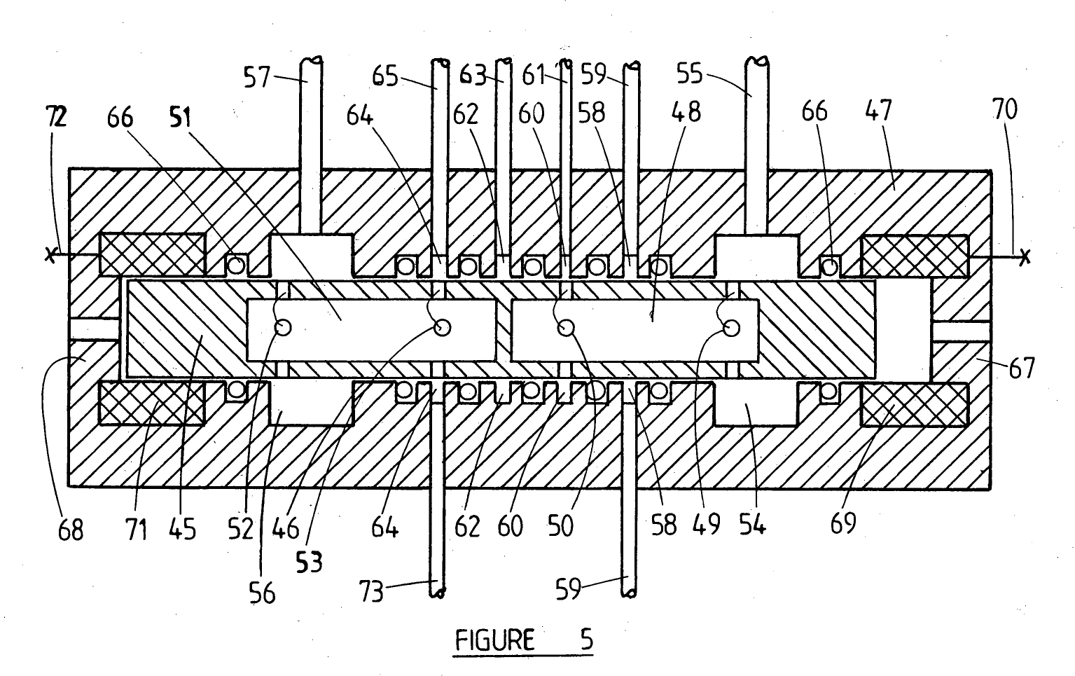

A cross section view of another example combined timed pressure and vent balanced valve is shown in FIGS. 4 and 5.

None of these apparatus drawings are to scale.

### Modified Common Rail Fuel Injection System

### DESCRIPTION OF THE PREFERRED EMBODIMENTS

A particular example form of modified common rail fuel injection system, for diesel engines, is illustrated in the schematic diagram of FIG. 1 and comprises:
(1) The fuel common rail, 1, with connected atomizing gas contactor chamber, 2, is supplied with fuel from the fuel tank, 3, by the high pressure fuel pump, 4, driven from the engine crankshaft, 5.
(2) The hydraulic common rail, 6, is supplied with hydraulic fluid from the hydraulic fluid tank, 7, by the high pressure hydraulic pump, 8, also driven from the engine crankshaft, 5.
(3) The fuel injector, 9, comprises, a fuel injector valve and driver, and a fuel on-off valve and driver. High Pressure fuel from the fuel common rail, 1, is supplied to the fuel on-off valve. High pressure fuel is supplied to the fuel injector valve only when the fuel on-off valve is opened by its driver. Fuel is injected into the engine combustion chamber, 10, only when the fuel injector valve is opened by its driver, and the fuel on-off valve is concurrently opened by its driver. Details of the fuel injector are shown in the schematic diagram of FIG. 2, as described hereinbelow.
(4) A first timed pressure and vent balanced valve, 11, applies pressure from the hydraulic common rail, 6, to the driver of the fuel on-off valve, in order to close the fuel on-off valve. The fuel pressure from the fuel common rail, 1, acts to open the fuel on-off valve when the timed pressure and vent valve, 11, vents hydraulic pressure, from the fuel on-off valve driver, back to the hydraulic fluid tank, 7.
(5) A second timed pressure and vent balanced valve, 13, applies pressure from the hydraulic common rail, 6, to the closing side of the fuel injector valve driver, in order to close the fuel injector valve, and vents hydraulic pressure from this closing side of the fuel injector valve driver, when the fuel injector valve is to be opened.
(6) A third timed pressure and vent balanced valve, 14, applies pressure from the hydraulic common rail, 6, to the opening side of the fuel injector valve driver, in order to open the fuel injector valve, and vents hydraulic pressure from this opening side of the fuel injector valve driver when the fuel injector valve is to be closed.
(7) All three timed pressure and vent balanced valves, 11, 13, 14, are driven to apply pressure, or to vent pressure, on the fuel on-off valve driver, and on the fuel injector valve driver, by solenoid drivers. These solenoid drivers are energized, and de-energized, and timed by a typical, prior art, adjustable solenoid power supply, 12, driven from the engine crankshaft, 5. In this way fuel is injected into the engine combustion chamber, 10, at the proper time, late during each compression stroke. Details of the timed pressure and vent balanced valves are shown in the schematic diagram of FIG. 3, as described hereinbelow. Piezoelectric drivers can be used to drive these timed pressure and vent balanced valves, instead of solenoid drivers.
(8) The adjustable solenoid power supply, 12, sends electric power from the source, 15, to the various solenoids of the three timed pressure and vent balanced valves, 11, 13, 14, via cam actuated mechanical switches, or sensor actuated electronic switches. The angular position of mechanical switch cam followers relative to the cam lobes on the crankshaft driven shaft, 5, can be adjusted to adjust the time of fuel injection, relative to piston motion in the engine cylinder, 10, so that fuel injection occurs during the compression stroke of each engine combustion chamber. Similarly, the time interval between the opening and the closing of the fuel injector valve, can be adjusted via an engine torque control lever, 16, to adjust the duration of fuel injector valve opening, and thus the quantity of fuel injected into each engine cylinder during each engine cycle, in order to adjust engine torque. Similarly the angular position of electronic switches relative to the rotating sensors on the shaft, 5, can be adjusted for these same purposes.
(9) The hydraulic fluid vent return lines, hv, return vented hydraulic fluid to the hydraulic fluid tank, 7, and the fuel vent return line, fv, returns leakage fuel to the fuel tank, 3. Electric power is delivered from the adjustable solenoid power supply, 12, to the several solenoid drivers in the three timed pressure and vent balanced valves, 11, 13, 14, via the connections, a, b, c, d, e, f.
(10) Descriptions of example atomizing gas contactor chambers, 2, are presented in my U.S. Pat. No. 7,281,500, and in my U.S. patent application Ser. No. 11/805,889, referred to in the Cross References to Related Applications and this material is incorporated herein by reference thereto.
(11) Several elements of a modified common rail fuel injection system of this invention can be essentially similar to corresponding elements used in the prior art, such as the high pressure fuel pump and driver, 4, and the fuel common rail, 1, and the adjustable solenoid power supply and driver, 12.
(12) The high pressure hydraulic pump and driver, 8, can be essentially similar to the high pressure fuel pump and driver, 4. In many prior art common rail fuel injection systems the high pressure fuel pump delivers not only that fuel to be injected into the engine combustion chamber, but also that fuel used as hydraulic fluid, to operate the fuel injector and then is vented back to the fuel tank. Thus on the modified common rail fuel injection system of this invention, the high pressure fuel pump, and the high pressure hydraulic pump, deliver together a total fluid quantity approximately equal to that delivered by a prior art high pressure fuel pump alone, and the fluid pumping power is thus essentially equal.

Several beneficial objects become available by this use of a hydraulic fluid high pressure pump and common rail for driving both the fuel on-off valve, and the fuel injector valve, instead of using the fuel high pressure pump and common rail for these added functions, such as these examples:
(a) A hydraulic fluid best suited to the driving of valves can be used, thus permitting use of a wide variety of fuels for engine operation, including slurry fuels, slurry fuels containing dissolved atomizing gases, multicomponent slurry fuels containing residual fuel particles and solid fuel particles, as well as conventional diesel engine fuels.
(b) When operating the engine on slurry fuels partially saturated with supplementary atomizing gas, less atomizing gas is required since fuel containing the gas is not used for driving valves.
(c) In some common rail fuel injector systems, flow restrictors are used in the injector valve drivers, to limit the rates of valve opening and closing. When using the separate hydraulic fluid for valves driving, as in this invention, the operation of these flow restrictors would not be impaired by slurry fuel particles or atomizing gas escape at reduced pressures.

### Fuel Injector

An example fuel injector, 9, is shown in cross section in the schematic drawing of FIG. 2, and comprises:
(13) A fuel injector valve, 17, with driver, 18. The fuel injector valve driver, 18, comprises a driver piston, 19, a valve closing chamber, 20, and a valve opening chamber, 21. The fuel injector valve, 17, is closed when high pressure hydraulic fluid is applied to the valve closing chamber, 20, from the hydraulic common rail, 6, via the second timed pressure and vent balanced valve, 13, while fluid is concurrently vented back to the hydraulic tank, 7, from the valve opening chamber, 21, via the third timed pressure and vent balanced valve, 14. The fuel injector valve, 17, is opened when high pressure hydraulic fluid is applied to the valve opening chamber, 21, via the third timed pressure and vent balanced valve, 14, while fluid is concurrently vented back to the hydraulic tank, 7, from the valve closing chamber, 20, via the second timed pressure and vent balanced valve, 13.
(14) A fuel on-off valve, 22, with driver, 23. The fuel on-off valve seat, 24, is next to the fuel injector valve seat, 25, with only a trace volume between these two valve seats. Fuel pressure from the fuel common rail, 1, is always applied to the valve opening surface, 26, of the fuel on-off valve, 22. The fuel on-off valve driver comprises the valve closing surface, 27, of the fuel on-off valve, together with the opposed, and always vented, back surface, 28. The fuel on-off valve, 22, is closed when high pressure hydraulic fluid is applied to the valve closing surface area, 27, from the hydraulic common rail, 6, via the first timed pressure and vent balanced valve, 11. The valve closing surface area, 27, is sufficiently larger than the valve opening surface area, 26, to assure valve closure by hydraulic pressure against fuel pressure. The fuel on-off valve, 22, is opened by the fuel pressure acting always on the valve opening area, 26, while fluid is concurrently vented back to the hydraulic fluid tank, via the first timed pressure and vent balanced valve, 11.
(15) By placing the valve seat, 24, of the fuel on-off valve, 22, very close to the valve seat, 25, of the fuel injector valve, 17, only a very small trace quantity of fuel is left between these valve seats. Thus, when slurry fuels, containing supplementary atomizing gas, are used only this small trace fuel quantity can undergo degasification between injections. This is another beneficial object of this modified common rail fuel injection system, that almost all of the slurry fuel will fully experience the improved supplementary atomization created by the atomizing gas, after the fuel is injected into the engine combustion chamber.

### Pressure and Vent Valves

An example timed pressure and vent balanced valve is shown in cross section in the schematic drawing of FIG. 3, suitable for use for each of the pressure and vent valves, 11, 13, 14, shown on FIG. 1, and comprises:
(16) A moveable valve element, 29, comprising a pressure valve, 30, a vent valve, 31, and a balance piston, 35, operates sealably within a pressure and vent balanced valve body, 32, which comprises a pressure valve seat, 33, and a vent valve seat, 34. When the pressure valve, 30, is closed on its seat, 33, the vent valve, 31, is open from its seat, 34, and when the vent valve is closed on its seat, the pressure valve is open from its seat.
(17) The moveable valve element, 29, is moved to open the pressure valve, 30, and to close the vent valve, 31, and thus to apply fluid pressure from the hydraulic common rail, 6, via connection, 38, to one of the valve drivers via connections, 41, whenever the pressure solenoid driver, 36, is alone energized via connection, 43. Similarly the moveable valve element is moved to close the pressure valve, and to open the vent valve, and thus to vent hydraulic fluid from the valve driver back to the hydraulic fluid tank, 7, whenever the vent solenoid driver, 37, is alone energized via connection, 44.
(18) The first timed pressure and vent balanced valve, 11, and the second timed pressure and vent balanced valve, 13, can be replaced with a single timed pressure and vent balanced valve, if concurrent opening and closing of both the fuel on-off valve, 22, and the fuel injector valve, 17, is to be used. It is somewhat preferable, however, to use two separate timed pressure and vent balanced valves, 11, 13, as described hereinbelow, so that opening and closing of the fuel on-off valve, 22, can be timed to precede slightly the opening and closing of the fuel injector valve, 17. By closing the fuel on-off valve, before closing the fuel injector valve, the residual fuel quantity between the two valve seats can be reduced, when using slurry fuels comprising supplementary atomizing gas, since fuel outgassing, between valve closures, will force more of this residual fuel into the engine cylinder, before closure of the fuel injector valve.
(19) Where fuel injector pressure is to be augmented during injection, by use of supplementary high pressure pumps, between the fuel common rail, 1, and the fuel injector, 9, the auxiliary pump can be driven by hydraulic fluid from the common rail, 6.
(20) The first, second and third timed pressure and vent balanced valves, 11, 13, 14, as described hereinabove, can be replaced with a single timed pressure and vent balanced sleeve valve, as illustrated in the cross section schematic drawings FIG. 4 and FIG. 5. This timed pressure and vent sleeve valve comprises the following elements:
(a) The balanced cleeve, 45, is moveable within the cylindrical cavity, 46, of the valve body, 47, between the two stops, 67, 68.
   The sleeve, 45, comprises a pressure chamber, 48, with a pressure inlet port, 49, and a pressure outlet port, 50. The sleeve, 45, further comprises a vent chamber, 51, with a vent discharge port, 52, and a vent inlet port, 53.
(b) The timed pressure and vent valve body, 47, additionally comprises: a pressure recess, 54, connected via pipe, 55, to the hydraulic common rail, 6; a vent recess, 56, connected via pipe, 57, to the hydraulic fluid tank, 7; a fuel injector closing pressure recess, 58, connected via pipe, 59, to the fuel injector valve closing chamber, 20, and also to the closing surface, 27, of the fuel on-off valve driver; a fuel injector opening pressure recess, 60, connected via pipe, 61, to the fuel injector valve opening chamber, 21; a fuel injector valve closing vent recess, 62, connected via pipe, 63, to the fuel injector valve opening chamber, 21; a fuel injector valve opening vent recess, 64, connected via pipe, 65, to the fuel injector valve closing chamber, 20, and connected via pipe, 73, to the fuel on-off valve closing surface, 27; these several pressure recesses, 54, 58, 60, and vent recesses, 56, 62, 64, are sealed from each other, and from the cylindrical cavity ends by the several “O” rings, 66.
(c) A timed pressure and vent valve closing driver solenoid, 69, when energized via connection, 70, pulls the balanced sleeve, 45, against the stop, 67, and thus aligns the several ports, 49, 50, 52, 53, to some of the recesses, 54, 58, 62, 56, as illustrated in FIG. 4, and hydraulic pressure is applied, and vented, on the fuel injector valve, 17, driver, 18, and on the fuel on-off valve, 22, driver, 23, so that both the fuel injector valve, 17, and the fuel on-off valve, 22, are closed.
(d) A timed pressure and vent valve opening driver solenoid, 71, when energized via connection, 72, pulls the balanced sleeve, 45, against the stop, 68, and thus aligns the several ports, 49, 50, 52, 53, to the recesses, 54,60, 64, 56, as illustrated in FIG. 5, and hydraulic pressure is applied and vented on the fuel injector valve, 17, driver, 18, and the fuel on-off valve, 22, driver, 23, so that both the fuel injector valve, 17, and the fuel on-off valve, 22, are opened.
(e) The timed pressure and vent balanced sleeve valve can thusly open and close the fuel injector valve, and the fuel on-off valve, in time with the engine compression stroke, by the adjustable solenoid power supply, 12, driven and timed from the engine crankshaft driven shaft, 5, as described hereinabove, so that fuel injection occurs during the compression stroke of each combustion chamber.
(f) The use of “O” ring seals between the balanced sleeve, 45, and the valve body, 47, and the several ports and recesses, limits the maximum usable pressure in the hydraulic common rail, 6, and thus may require larger driver piston areas on the fuel injector valve driver, 18, and the fuel on-off valve driver, 23.

### Industrial Uses of This Invention

The residual fuel content of newly discovered crude oils has tended to increase with the passage of time. Indeed, some newer oil fields, such as the Athabaska tar sands, yield a crude oil which is essentially wholly residual fuel. Currently, direct transport use of these high viscosity residual fuels is confined to large bore, slow speed, marine diesel engines. Other transport engines currently require use of distillate petroleum fuels, which are expensive and in progressively shorter supply. Such distillate petroleum fuels can be prepared from residual portions of crude oil, but stock and hence energy losses result.

Preatomization of residual fuels, as also coal or coke fuels, into a fuel particle in water slurry, appears a promising means for utilizing residual fuels in smaller bore, higher speed, diesel engines. These smaller bore, higher speed diesel engines are the major power source for the critical transport portion of our economy, and are currently a major consumer of the limited supplies of expensive distillate petroleum fuels.

Residual petroleum fuels are currently used in industrial furnaces and steam boiler furnaces. But these stationary fuel uses can be more readily adapted to use of lower cost and widely available coal than can transport industry engines. In this way, wider use of residual petroleum fuel in the critical transport industry can contribute to achieving national energy independence.

Recent efforts to derive fuels, suitable for use in piston internal combustion engines, from farm crop materials, have been directed toward liquid fuels, such as ethanol, and modified vegetable oils. Only the small food portion of the total crop cellulose product is used to create an even smaller yield of ethanol or vegetable oil. Preferably the usual farm cellulose product could be divided into three portions: a food portion for human and livestock consumption; a fertilizer portion to maintain soil fertility; and a fuel portion to be shredded, and blended into a slurry fuel. In this way a greater yield of energy product per acre of farmland, could be realized, without impairing the yield of food product.

Many slurry fuel combinations, as well as non slurry fuels, can be efficiently used in diesel engines equipped with the supplementary atomizer apparatus of this invention, of which the following are examples:
(a) A two component slurry of, small particles of residual petroleum fuel, suspended in a continuous water phase;
(b) A three component slurry of, small particles of residual fuel, plus separate small particles of igniter fuel, such as high cetane number distillate petroleum fuel, suspended in a continuous water phase. Such use of igniter fuel could decrease excess fuel penetration by shortening the ignition delay time interval;
(c) A four component slurry of, small particles of residual petroleum fuel containing finely shredded farm cellulose particles, plus separate small particles of igniter fuel, suspended in a continuous water phase. For this four component slurry the atomizing gas could advantageously comprise gas portions soluble in the residual petroleum fuel, such as natural gas, as well as gas components soluble in the water phase, such as carbon dioxide. The resulting supplementary atomization of the residual fuel particles would create improved oxygen access to the farm cellulose particles;
(d) Another four component slurry of small particles of residual petroleum fuel containing finely divided coal particles, plus separate small particles of igniter fuel, suspended in a continuous water phase. Again the preferred atomizing gas comprises gases soluble in residual petroleum fuel, as well as gases soluble in water. The adverse wear of fuel injector valves, observed earlier with coal particle in water slurries, may be reduced, or eliminated, by coating the coal particles with residual petroleum fuel.
(e) A two component slurry of finely shredded farm cellulose particles suspended in a continuous distillate petroleum fuel phase. A petroleum soluble gas, such as natural gas, could be used as the atomizing gas;

These example slurries are gas dissolving fluids, with some portions being non gaseous fuels, and with some portions being capable of dissolving gases. Portions of the atomizing gases, used with these gas dissolving fluids, are soluble in portions of the gas dissolving fluid.

Small and medium bore diesel engines fitted with modified common rail fuel injection systems of this invention can operate well on these several types of slurry fuels, as well as on conventional distillate petroleum fuels. This multifuel capability of these engines is a substantial benefit in today's uncertain and volatile fuels market.

Having thus described my invention, what I claim is:

1. A modified common rail fuel injector system, for use on piston and cylinder internal combustion engines which comprise a number of engine combustion chambers, each said engine combustion chamber being driven through a cycle by an engine crankshaft, and each cycle comprising a compression process, said modified common rail fuel injector system comprising:
a source of engine fuel;
a separate source of hydraulic fluid;
a fuel high pressure common rail;
a hydraulic fluid high pressure common rail;
a fuel high pressure pump with drive means for driving said fuel pump from said engine crankshaft, said fuel high pressure pump being connected to transfer fuel from said source of engine fuel into said fuel high pressure common rail;
a hydraulic fluid high pressure pump with drive means for driving said fluid pump from said engine crankshaft, said hydraulic fluid high pressure pump being connected to transfer fluid from said source of hydraulic fluid into said hydraulic fluid high pressure common rail;
a number of fuel injector means for transferring fuel, at high pressure, from said fuel high pressure common rail, into each said engine combustion chamber, during each said compression process, each said fuel injector means comprising:
(a) a fuel injector valve means for opening and closing a fuel flow path into one engine combustion chamber, and comprising drive means for opening and closing said fuel injector valve;
(b) a fuel flow connection from said fuel high pressure common rail to said fuel injector means;
(c) a fuel on-off valve means for opening and closing a fuel flow path, from said fuel flow connection from said fuel common rail, to said fuel injector valve, and comprising drive means for opening and closing said fuel on-off valve;
(d) whereby fuel can flow at high pressure from said common rail into each engine combustion chamber when, said connected one fuel injector valve is opened by its drive means, and, concurrently, said connected fuel on-off valve is opened by its drive means;
(e) and further whereby fuel cannot flow from said common rail into each engine combustion chamber when said fuel injector valve is closed by its drive means, or when said fuel on-off valve is closed by its drive means;
a number of timed pressure and vent valve means, equal to said number of fuel injector means, each timed pressure and vent valve means being operative to apply hydraulic pressure, from said hydraulic common rail, to the fuel injector valve driver means, and to the fuel on-off valve driver means, of one fuel injector means, each timed pressure and vent valve being also operative to vent hydraulic pressure from the fuel injector valve driver means and the fuel on-off valve driver means of said one fuel injector means;
each said timed pressure and vent valve means comprising pressure and vent valve driver means for moving said timed pressure and vent valve means; first into a fuel injector position, where hydraulic pressure, from the hydraulic common rail, is applied to the fuel injector valve driver, to drive the fuel injector valve open, and hydraulic fluid is vented from the fuel injector valve driver, to allow the fuel injector valve to open, and hydraulic fluid is vented from the fuel on-off valve driver, to allow fuel pressure, from the fuel common rail to drive the fuel on-off valve open, so that fuel is injected into said engine combustion chamber; and second, after a fuel injector time interval, into a fuel off position, where hydraulic pressure, from the hydraulic common rail, is applied to the fuel on-off valve driver to close the fuel on-off valve against the fuel common rail pressure, and hydraulic pressure from the hydraulic common rail, is applied to the fuel injector valve driver to drive the fuel injector valve closed, and hydraulic fluid is vented from the fuel injector valve driver, to allow the fuel injector valve to close, so that fuel is not injected into said engine combustion chamber;
each said sequence of a first fuel injection position of said timed pressure and vent valve, followed, after a fuel injection time period, by a second fuel off position of said timed pressure and vent valve, constituting a fuel injection process, during which a single fuel quantity is injected into said engine combustion chamber;
each said timed pressure and vent valve means comprising vent return connections to said source of hydraulic fluid, so that vented hydraulic fluid can be returned to said source;
a power supply means, operative upon said pressure and vent valve drive means, and driven and timed by the crankshaft of said internal combustion engine, so that, each said pressure and vent valve means is moved into said first fuel injector position during the compression stroke of the connected engine combustion chamber, and so that each said pressure and vent valve means is next moved into said second fuel off position, after said fuel injector time interval, later during that same compression stroke of the connected engine combustion chamber;
said power supply means further comprising engine torque adjustment means for adjusting the duration of said fuel injector time interval, so that each single fuel quantity, injected into each engine combustion chamber, can be adjusted, in order to adjust engine torque output.

2. A modified common rail fuel injection system, as described in claim 1, wherein said fuel high pressure common rail additionally comprises a contactor chamber, for contacting fuel with supplementary atomizing gas, said contactor chamber being flow connected to said high pressure fuel common rail.
wherein said fuel high pressure pump transfers fuel, from said source of engine fuel, into said contactor chamber, and fuel then flows into said fuel high pressure common rail.

3. A modified common rail fuel injection system, as described in claim 2, wherein said contactor chamber is open flow connected to said high pressure fuel common rail, so that pressure is essentially equal in the contactor chamber and the fuel common rail.

4. A modified common rail fuel injection system, as described in claim 2, wherein said contactor chamber is flow connected to said high pressure fuel common rail via a supplementary fuel transfer pump, so that pressure in said contactor chamber can be less than pressure in said fuel common rail.
